(19) United States
(12) Patent Application Publication
(10) Pub. No.: US 2007/0127606 A1
(43) Pub. Date: Jun. 7, 2007

(54) Synchronization and detection method capable of resisting noise and waveform distortion in communication system and correlator thereof

(76) Inventors: Yeong-Luh Ueng, Hsinchu (TW); Jinn-Ja Chang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/295,590

(22) Filed: Dec. 7, 2005

(51) Int. Cl. H04L 27/06; H04L 7/00

(52) U.S. Cl. 375/343; 375/365

(57) ABSTRACT

A synchronization method and a detection method capable of resisting noise and waveform distortion in a communication system and a correlator thereof are proposed. In the method, over-sampling is performed to a preamble and a synchronization word in an access code, and a different weighting value is assigned to each sampled point based on its reliability. A correlator is then used to calculate a correlation value. The time instant when this correlation value exceeds an initial threshold is used as the time instant to activate a timer. The time instant when the calculated correlation value is maximal within the time interval from the timer is activated to a predetermined observation time interval is used as the optimum synchronized timing instant to accomplish bit synchronization and frame synchronization at the same time. Moreover, the optimum synchronized timing instant can be used as a reference instant for bit detection to enhance the capability of resisting noise and waveform distortion.

### BACKGROUND OF THE INVENTION

1 . Field of the Invention

The present invention relates to a synchronization and detection technology and, more particularly, to a synchronization method and a detection method capable of resisting noise and waveform distortion in a communication system such as a Bluetooth communication system and a correlator thereof.

2. Description of Related Art

The wireless technology has been widely applied in human life. Low power wireless technologies are trends in the development of wireless products. For instance, the Bluetooth technology is a transmission technique for short distance communication, and provides voice and data transmission between different information appliances through short distance RF (radio frequency) connection.

The Bluetooth technology operates at the 2.4 GHz ISM (industrial, scientific and medical) band. The ISM band is an unlicensed band that is used for data transmission between wireless equipments in industrial, scientific and medical fields. The Bluetooth technology can simultaneously provide services for data and voice transmission, and adopts various techniques such as time division duplex (TDD), frequency hopping, and Gaussian frequency shift keying (GFSK) modulation. The basic Bluetooth frame (or package) format is shown in FIG. 1, and is usually composed of a 72-bit access code, a 54-bit package header, and a 0˜2745-bit data payload. The access code can be used to confirm the identities of all transmitted packages, and can be simultaneously used for DC compensation and synchronization. The package header is primarily used to define the type of a Bluetooth package. The payload is used for carrying user data. The access code includes a 4-bit preamble, a 64-bit synchronization word, and a 4-bit trailer.

As shown in FIG. 1, in the conventional synchronization and detection algorithm of Bluetooth communication, each bit of the 4-bit preamble is first over sampled, and the early-late gate method or correlator method is then used to find out the optimum timing instant to accomplish bit synchronization. Next, the subsequent synchronization word field is sampled at the data rate based on the synchronized timing instant. A correlator is then used to calculate a correlation value between the received bit stream to be frame synchronized and a known synchronization word, and the frame synchronization is completed when the correlation value exceeds a threshold. Detection is then performed to the subsequent package header and payload based on the synchronized timing instant. Because a Bluetooth communication system is a frequency hopping system, the frequency synthesizer needs to change the frequency frequently. The preamble data is thus unstable. Moreover, when the signal-to-noise ratio (SNR) is low, the preamble data is also unstable. Hence, only based on the preamble data for bit clock synchronization (i.e., bit synchronization), the obtained timing instant is unreliable. Furthermore, the result obtained by using the synchronized timing instant to perform bit detection and frame synchronization to the subsequent waveform is not good enough.

Besides, the threshold selection is difficult in frame synchronization. If the threshold is too low, erroneous synchronization easily arises; if the threshold is too high, synchronization can hardly be accomplished and the whole frame is lost under the situation that there is any erroneous bit or waveform distortion. In consideration of the above problems, the present invention proposes a synchronization method and a detection method capable of resisting noise and waveform distortion and a correlator thereof to improve the drawbacks in the prior art.

### SUMMARY OF THE INVENTION

An object of the present invention is to provide a synchronization method and a detection method capable of resisting noise and waveform distortion in a communication system and a correlator thereof, in which not only the preamble but also the synchronization word are over sampled and a different weighting value is assigned to each sampled point based on its reliability to calculate the optimum synchronized timing instant for bit synchronization, thereby accomplishing frame synchronization and bit detection.

Another object of the present invention is to provide a synchronization method and a detection method capable of resisting noise and waveform distortion in a communication system and a correlator thereof, in which bad bit synchronization caused by waveform distortion occurred in the transmission channel or RF front end and during the demodulation process, and erroneous bits caused by low SNR in the prior art can be improved, thereby decreasing the influences of bad bit synchronization on bit detection and frame synchronization in the prior art.

Another object of the present invention is to provide a synchronization method and a detection method capable of resisting noise and waveform distortion in a communication system and a correlator thereof, in which the threshold setting of the correlator is more flexible to reduce the probability of the occurrence of missing synchronization or erroneous synchronization.

To achieve the above objects, the present invention provides a synchronization method capable of resisting noise and waveform distortion in a communication system. The method comprises the steps of: receiving a frame including an access code, a package header and a data payload, the access code being composed of a preamble, a synchronization word, and a trailer; performing over-sampling to each bit of the receiving frame (or the incoming bit stream) to be synchronized and performing over-sampling to each bit of a known synchronization word with a different weighting value assigned to each sampled point in a bit based on its reliability; using a correlator to calculate a correlation value between the known synchronization word and the incoming bit stream to be synchronized; and using the time instant when the correlation value exceeds an initial threshold as the time instant to activate a timer, and using the time instant when the calculated correlation value is maximal within a time interval from the timer is activated to a predetermined observation time interval as an optimum synchronized timing instant to accomplish both the bit synchronization and frame synchronization.

After the optimum synchronization is achieved, the present invention also provides a bit detection method comprising the steps of: using the optimum synchronized timing instant as a reference sampling instant; performing over-sampling to each bit in the fields of header and payload in a frame, assigning a different weighting value to each sampled point based on its reliability; and calculating a correlation value between each bit in the fields of header and payload in the frame and signals 0/1 to perform bit detection.

The present invention also provides a correlator used in a synchronization method and a detection method capable of resisting noise and waveform distortion in a communication system. The correlator comprises a multiplier, an accumulator, a comparator, a timer and at least two registers. The multiplier and the accumulator are used to calculate a correlation value between a known synchronization word and an incoming bit stream to be synchronized. The comparator determines whether the correlation value exceeds a threshold. Matched with the registers, the timer is activated when the correlation value exceeds an initial threshold to keep timing till a predetermined observation time interval, and uses a time instant when the correlation value is maximal within this time interval as an optimum synchronized timing instant (or bit synchronization point) so as to accomplish frame synchronization at the same time.

### BRIEF DESCRIPTION OF THE DRAWINGS

The various objects and advantages of the present invention will be more readily understood from the following detailed description when read in conjunction with the appended drawing, in which:

FIG. 1 is a diagram showing a basic frame format of the Bluetooth technology;

FIG. 2 is a flowchart of a synchronization method and a detection method of the present invention;

FIG. 3 is a diagram showing how to perform over-sampling to the fields of preamble and synchronization word of a frame according to an embodiment of the present invention;

FIG. 4 is a diagram showing that a different weighting value is assigned to each sampled point of bits in a synchronization word based on its different reliability according to an embodiment of the present invention; and

FIG. 5 is a block diagram of a correlator used in the present invention.

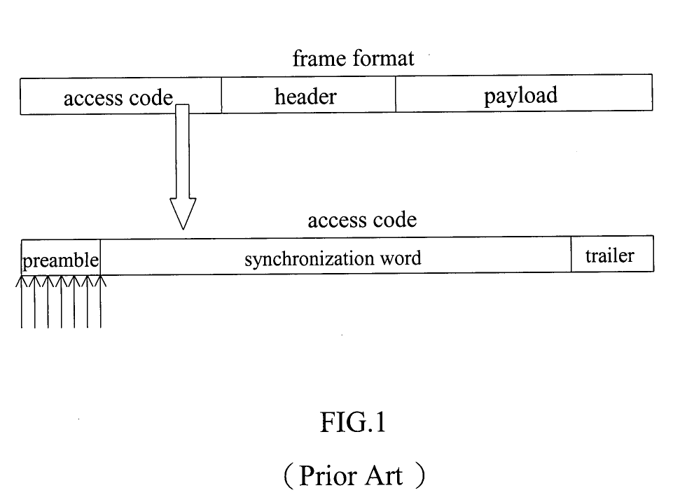

### DETAILED DESCRIPTION OF THE PREFERRED EMBODIMENTS

In the present invention, over-sampling is performed to a synchronization word in an access code (over-sampling to a preamble can also be added), and a different weighting value is assigned to each sampled value based on its reliability to calculate the optimum synchronized timing instant for bit synchronization so as to accomplish the objects of frame synchronization and bit detection.

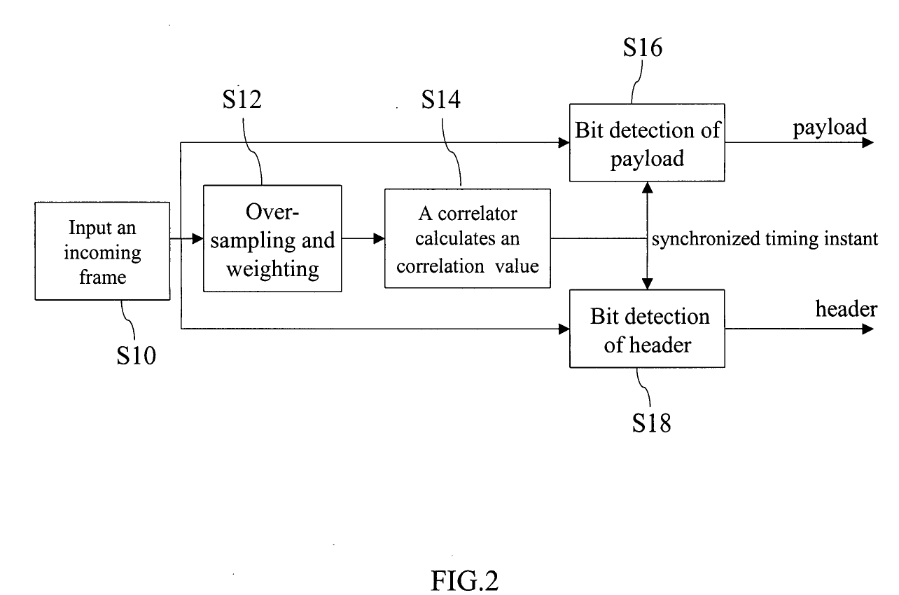

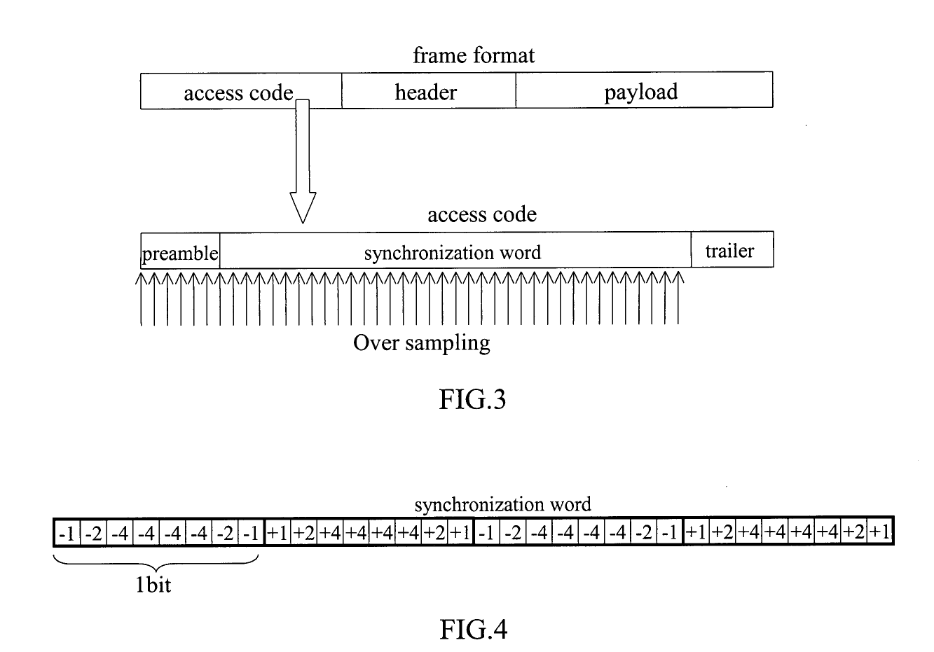

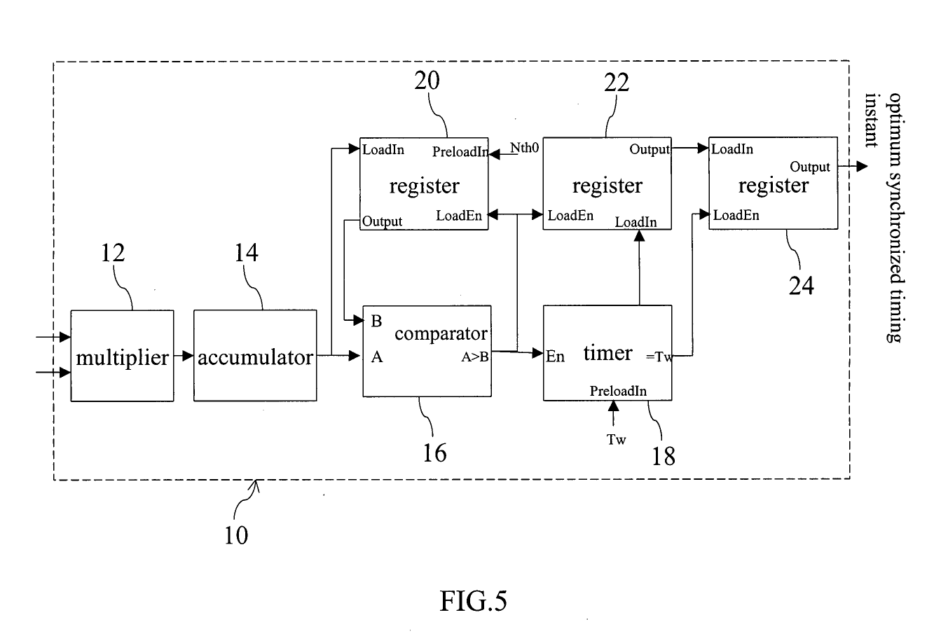

As shown in FIG. 2, the synchronization method and the detection method capable of resisting noise and waveform distortion in a communication system comprises the following steps. First, receive an incoming frame as input (Step S10). The frame includes an access code composed of a preamble, a synchronization word and a trailer, as shown in FIG. 3. Over-sampling is then performed to each bit in the bit stream of the preamble and synchronization word to be synchronized (Step S12). In Step S12, over-sampling is also performed to each bit of a known synchronization word (or adding a preamble), and a different weighting value is assigned to each sampled point based on its reliability. With a Gaussian frequency shift keying (GFSK) demodulator as an example, lower weighting values are assigned to boundary sampled points in a bit, and larger weighting values are assigned to middle sampled points in a bit of the known synchronization word. Reference is made to FIG. 4, the signs + and − in the figure represent digital signals 1 and 0, respectively, and the digits represent the weighting values. The larger the digit is, the larger the weighting is. It can be clearly seen that lower weighting values are assigned to boundary sampled points, and larger weighting values are assigned to middle sampled points in each bit of the synchronization word.

Reference is made to FIG. 2 again. A correlator is used to calculate a correlation value between the known synchronization word and the bit stream to be synchronized (Step S14). The time instant when the correlation value calculated by the correlator exceeds an initial threshold is used as the time instant to activate a timer, and the time instant when the calculated correlation value is maximal within a time interval from the timer is activated to a predetermined observation time interval is used as an optimum synchronized timing instant to accomplish both bit synchronization and frame synchronization at the same time. The above observation time interval cannot exceed a duration of tail bits of the access code that are not used in the step of using the correlator to calculate the correlation value. For example, the timing interval usually does not exceed the duration of the trailer.

After the optimum time synchronization point is obtained, the subsequent bit detection can be carried out, including bit detection of the payload (Step S16) and bit detection of the header (Step S18). In Step S16, the optimum synchronized timing instant is used as a reference sampling instant, and over-sampling is performed to each bit in the field of payload in a frame, and a different weighting value is assigned to each sampled point based on its reliability, and a correlation value between each bit in the field of payload in the frame and signals 0/1 is obtained to perform bit detection. If the correlation value of the over-sampled bit with the signal 0 is larger than that with the signal 1, the bit is determined to be 0; and if the correlation value of the over-sampled bit with the signal 1 is larger than that with the signal 0, the bit is determined to be 1. On the other hand, in Step S18, because a repetition code with a code rate of R is used as an FEC (forward error correction) code, it can be taken as a bit stream with a bit rate of R times the original bit rate (e.g., one third the original bit rate). The above same method is then used to finish the detection of the header part, and decoding of the repetition code with a code rate of R is simultaneously completed.

In addition to the synchronization method and the detection method, the present invention also provides a correlator used in the synchronization method and the detection method. As shown in FIG. 5, a correlator 10 comprises a multiplier 12, an accumulator 14, a comparator 16, a timer 18, and several registers 20, 22, 24. The multiplier and the accumulator are used for parallel processing the over sampled and weighted synchronization word in the access code and the over sampled bit stream to be synchronized and calculating a correlation value between the bit stream and the weighted synchronization word. This correlation value is then sent to the comparator 16. The comparator 16 determines whether the correlation value (A) exceeds a threshold (B) or not. Of course, the correlation value sent to the comparator 16 is also sent to the register 20. Whether this correlation value is loaded into the register 20 is controlled by a state of a signal LoadEn. The correlation value is loaded into the register 20 and also output to the comparator 16 only when the present correlation value (A) exceeds the present threshold (B) and hence the signal LoadEn goes from low to high. At the beginning, a predetermined value Nₜₕ₀ is stored in the register 20 and output to a B input end of the comparator 16 as an initial threshold. When the comparator 16 determines the correlation value is larger than the initial threshold, the output of an A>B end of the comparator 16 goes from low to high to activate the timer 18. The timer 18 is activated when the correlation value exceeds the initial threshold. Once activated, the timer 18 won't be turned off and reset during the frame synchronization process for current frame (package). After activated, the timer 18 starts to keep timing, and the register 22 is used to temporarily store the timing instant of the timer 18. Whether the timing instant of the timer 18 is loaded into the register 22 is controlled by the state of the signal LoadEn. The timing instant of the timer 18 is loaded into the register 22 only when the present correlation value (A) exceeds the present threshold (B) and hence the signal LoadEn goes from low to high. Therefore, when the timer 18 keeps timing till a predetermined time interval Tw, the value in the register 22 is the timing instant when the calculated correlation value is maximal. When the timer 18 keeps timing till the predetermined time interval Tw, the signal input LoadEn of the register 24 goes from low to high, and the output of the register 22 will be stored into the register 24 and used as the optimum synchronized timing instant. The register 20 is also connected to the comparator 16 for output of the stored value to the comparator 16 so that when the accumulator 14 outputs a correlation value larger than the present threshold, the stored value of the register 20 can be changed to adjust the threshold of the comparator 16 according to the stored value. The setting of the threshold of the correlator 10 is therefore more flexible to reduce the probability of the occurrence of missing synchronization or erroneous synchronization. Besides, the timer 18 will load in a value Tw in advance as the timing interval of the timer 18.

In addition to the 4-bit preamble, the present invention also performs over-sampling to the 64-bit synchronization word. Because the number of over-sampled bits used in the calculation of the correlation value is larger, the correctness of the synchronized timing instant won't be affected even if there are some errors in the over-sampled values. Moreover, in the present invention, a different weighting value is assigned to each sampled point based on its reliability to calculate the optimum synchronized timing instant so as to accomplish frame synchronization and bit detection. In the prior art, only the preamble is over sampled. Because the number of over-sampled bits used in the calculation of the correlation value is smaller, the synchronized timing instant will be badly affected by noise and waveform distortion. Moreover, if there is any error, missing synchronization or erroneous synchronization will occur to cause a lower correctness. Therefore, the present invention can indeed improve bad synchronized timing instant or missing synchronization caused by waveform distortion occurred in the transmission channel or RF front end and during the demodulation process, and erroneous bit synchronization caused by low SNR, thereby decreasing the influences of bad synchronized timing instant to bit detection and frame synchronization in the prior art.

The above embodiment is exemplified with the GFSK modulation, in which the sampled value of each bit can be represented by a real number. Other modulations can also be used in the present invention, and the sampled value of each bit can be represented by a complex number.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A synchronization method capable of resisting noise and waveform distortion in a communication system, said method comprising the steps of receiving a frame (or bit stream to be synchronized) including an access code composed of a preamble, a synchronization word, and a trailer;
performing over-sampling to each bit in the bit stream to be synchronized and performing over-sampling to each bit of a known synchronization word with a different weighting value assigned to each sampled point based on its reliability;
using a correlator to calculate a correlation value between said known synchronization word and said bit stream to be synchronized; and
using the time instant when said the correlation value exceeds an initial threshold as the time instant to activate a timer, and using the time instant when said calculated correlation value is maximal within a time interval from said timer is activated to a predetermined observation time interval as an optimum synchronized timing instant to accomplish both bit synchronization and frame synchronization.

2. The synchronization method capable of resisting noise and waveform distortion in a communication system as claimed in claim 1, wherein in said step of performing over-sampling, over-sampling can also be performed to said preamble that can also be included in the calculation of said correlation value by said correlator.

3. The synchronization method capable of resisting noise and waveform distortion in a communication system as claimed in claim 1, wherein lower weighting values are assigned to boundary sampled points of a bit, and larger weighting values are assigned to middle sampled points of a bit in said synchronization word.

4. The synchronization method capable of resisting noise and waveform distortion in a communication system as claimed in claim 3, wherein said synchronization word is GFSK modulated.

5. The synchronization method capable of resisting noise and waveform distortion in a communication system as claimed in claim 1, wherein a time instant when said correlation value calculated by said correlator exceeds a threshold is used as a time instant to activate a timer to start keeping timing.

6. The synchronization method capable of resisting noise and waveform distortion in a communication system as claimed in claim 1, wherein said timing interval cannot exceed a duration of tail bits of said access code that are not used in said step of using said correlator to calculate said correlation value.

7. The synchronization method capable of resisting noise and waveform distortion in a communication system as claimed in claim 5, wherein said correlator makes use of two registers matched with said timer and a comparator to calculate a time instant when said correlation value is maximal.

8. The synchronization method capable of resisting noise and waveform distortion in a communication system as claimed in claim 1, wherein a bit detection step can further be carried out after said step of obtaining said optimum synchronized timing instant.

9. A detection method capable of resisting noise and waveform distortion in a communication system, said method comprising the steps of:
obtaining an optimum synchronized timing instant as a reference sampling instant;
performing over-sampling to each bit in the fields of header and payload in a frame, and assigning a different weighting value to each sampled point based on its reliability; and
calculating a correlation value between each bit in the fields of header and payload in a frame and signals 0/1 to perform bit detection.

10. The detection method capable of resisting noise and waveform distortion in a communication system as claimed in claim 9, wherein said optimum synchronized timing instant is acquired by using the steps of:
receiving a frame (or bit stream to be synchronized) including an access code composed of a preamble, a synchronization word, and a trailer;
performing over-sampling to each bit in the bit stream to be synchronized and performing over-sampling to each bit of a known synchronization word with a different weighting value assigned to each sampled point based on its reliability;
using a correlator to calculate a correlation value between said known synchronization word and said bit stream to be synchronized; and
using a time instant when said correlation value exceeds an initial threshold as the time instant to activate a timer, and using the time instant when said calculated correlation value is maximal within a time interval from said timer is activated to a predetermined observation time interval as an optimum synchronized timing instant.

11. The detection method capable of resisting noise and waveform distortion in a communication system as claimed in claim 9, wherein if the correlation value of said over sampled bit with signal 0 is larger than that with signal 1, said bit is determined to be 0; and if the correlation value of said over sampled bit with signal 1 is larger than that with signal 0, said bit is determined to be 1.

12. The detection method capable of resisting noise and waveform distortion in a communication system as claimed in claim 9, wherein the format of said frame contains an access code, a package header and a payload.

13. The detection method capable of resisting noise and waveform distortion in a communication system as claimed in claim 12, wherein said bit detection can be a payload bit detection or a header bit detection.

14. The detection method capable of resisting noise and waveform distortion in a communication system as claimed in claim 13, wherein in said step of performing said header bit detection, the bit rate of said header can be modified to be R times the original bit rate, where R is a code rate of a repetition code used by a field of said header.

15. The detection method capable of resisting noise and waveform distortion in a communication system as claimed in claim 10, wherein in said step of performing over-sampling, over-sampling can also be performed to said preamble that can also be included in the calculation of said correlation value by said correlator.

16. The detection method capable of resisting noise and waveform distortion in a communication system as claimed in claim 10, wherein lower weighting values are assigned to boundary sampled points of a bit, and larger weighting values are assigned to middle sampled points of a bit in said synchronization word.

17. The detection method capable of resisting noise and waveform distortion in a communication system as claimed in claim 16, wherein said synchronization word is GFSK modulated.

18. The detection method capable of resisting noise and waveform distortion in a communication system as claimed in claim 10, wherein a time instant when said correlation value calculated by said correlator exceeds a threshold is used as a time instant to activate a timer to start keeping timing.

19. The detection method capable of resisting noise and waveform distortion in a communication system as claimed in claim 10, wherein said timing interval cannot exceed a duration of tail bits of said access code that are not used in said step of using said correlator to calculate said correlation value.

20. The detection method capable of resisting noise and waveform distortion in a communication system as claimed in claim 18, wherein said correlator makes use of two registers matched with said timer and a comparator to calculate a time instant when said correlation value is maximal.

21. A correlator used in a synchronization method and a detection method capable of resisting noise and waveform distortion in a communication system, said correlator comprising:
a multiplier and an accumulator for parallel processing an over sampled and weighted known synchronization word in an access code and an over sampled bit stream to be synchronized and calculating a correlation value between said bit stream and said synchronization word;
a comparator for receiving said correlation value and determining whether said correlation value exceeds a threshold;
a timer activated when said correlation value exceeds said threshold to keep timing till a predetermined observation time interval and using a time instant when said correlation value is maximal within this time interval as an optimum synchronized timing instant; and
at least two registers connected to said comparator and said timer and used to temporarily store the correlation value when a present correlation value exceeds a present threshold and a timing instant of said timer, and to adjust said threshold of said comparator according to said present correlation value.

22. The correlator as claimed in claim 21, wherein said timing interval cannot exceed a duration of tail bits of said access code that are not used in said step of using said correlator to calculate said correlation value.

23. The correlator as claimed in claim 21, wherein said two registers are a first register and a second register.

24. The correlator as claimed in claim 23, wherein when said correlation value is sent to said comparator, said correlation value will also be sent to said first register, the said correlation value is loaded into said first register only when the said correlation value is larger than the present threshold of said comparator.

25. The correlator as claimed in claim 23, wherein when said timer starts keeping timing, said second register can temporarily store the timing instant of said timer, the said timing instant is loaded into said second register only when the present correlation value is larger than the present threshold of the comparator.

26. The correlator as claimed in claim 23, wherein when said accumulator outputs a correlation value larger than the original threshold, the stored value of said first register can be changed and the threshold of said comparator can be adjusted according to said stored value.

27. The correlator as claimed in claim 23, wherein said timer will pre-load a value Tw as a timing interval of said timer.
